(19) United States
(12) Patent Application Publication
(10) Pub. No.: US 2008/0137262 A1
(43) Pub. Date: Jun. 12, 2008

(54) Methods and systems for capacitors

(75) Inventors: Pushpa Mahalingam, Richardson, TX (US); Alexander Wong, Plano, TX (US); Marshall O. Cathey, Denison, TX (US); Weidong Tian, Dallas, TX (US); Yvonne Dianne Patton, Plano, TX (US); Joseph William Palmer, Plano, TX (US); Billy Alan Wofford, Dallas, TX (US)

Correspondence Address: TEXAS INSTRUMENTS INCORPORATED, P O BOX 655474, M/S 3999, DALLAS, TX, 75265, US

(73) Assignee: Texas Instruments Inc.

(21) Appl. No.: 11/637,283

(22) Filed: Dec. 12, 2006

(51) Int. Cl. H01G 4/30; H01G 4/06; H01G 9/00

(52) U.S. Cl. 361/301.4; 361/311; 29/25.03

(57) ABSTRACT

One embodiment of the present invention relates to a capacitor. The capacitor includes a first electrode and a capacitor dielectric layer along-side the first capacitor electrode. A second electrode is found along-side the capacitor dielectric layer includes a number of inter-layers that are configured to prevent defects in the second capacitor electrode. Other methods and devices are also disclosed.

### FIELD OF INVENTION

The present invention relates generally to semiconductor devices and more particularly to improved methods and systems for capacitors.

### BACKGROUND OF THE INVENTION

Capacitors are devices that are formed by sandwiching a thin layer or film of dielectric material between two layers of conductive materials, usually metals. These two conductive layers may be referred to as electrodes.

One problem with some existing capacitors is that if a contact is formed on the top conductive plate, it can punch-through the top plate and the dielectric layer if there are any cracks in the top plate, thereby shorting out the capacitor and substantially compromising the capacitor's ability to store charge. Because capacitance is a function of the distance between the electrodes (i.e., the thickness of the dielectric layer), capacitors with a relatively thin dielectric layer have a relatively high capacitance, and may be referred to as “high density” capacitors. The contacts on the top conductive layer are more likely to punch through the dielectric for high density capacitors due to thinner dielectrics.

Another ongoing challenge in the microelectronics industry is to fit more devices into a smaller area. As devices continue to shrink, however, challenges arise. With regard to capacitors formed over a semiconductor substrate, higher the via density on the capacitors (more number of vias per unit area), higher the chances of the capacitors being shorted out if there are cracks in the capacitor top plate. Nonetheless, it would be desirable to fabricate a capacitor in a manner that mitigates the adverse effects associated with capacitor plate cracking while concurrently allowing the size of the capacitor to be reduced.

Therefore, a need has arisen to provide systems and methods relating to capacitors that cure some deficiencies of the prior art.

### SUMMARY OF THE INVENTION

The following presents a simplified summary in order to provide a basic understanding of one or more aspects of the invention. This summary is not an extensive overview of the invention, and is neither intended to identify key or critical elements of the invention, nor to delineate the scope thereof. Rather, the primary purpose of the summary is to present some concepts of the invention in a simplified form as a prelude to the more detailed description that is presented later.

One embodiment of the present invention relates to a capacitor. The capacitor includes a first electrode and a capacitor dielectric layer along-side the first capacitor electrode. A second electrode is found along-side the capacitor dielectric layer includes a number of inter-layers that are configured to prevent defects in the second capacitor electrode.

The following description and annexed drawings set forth in detail certain illustrative aspects and implementations of the invention. These are indicative of only a few of the various ways in which the principles of the invention may be employed.

### BRIEF DESCRIPTION OF THE DRAWINGS

FIG. 1 relates to one embodiment of a capacitor;

FIG. 2 relates to one embodiment of a capacitor;

FIG. 3 relates to one embodiment of a method of forming a capacitor;

FIG. 4-17 relate to one embodiment of a method for forming a capacitor; and

FIG. 18 relates to one embodiment of a stacked capacitor.

### DETAILED DESCRIPTION OF THE INVENTION

One or more implementations of the present invention will now be described with reference to the attached drawings, wherein like reference numerals are used to refer to like elements throughout. The drawings are not necessarily drawn to scale.

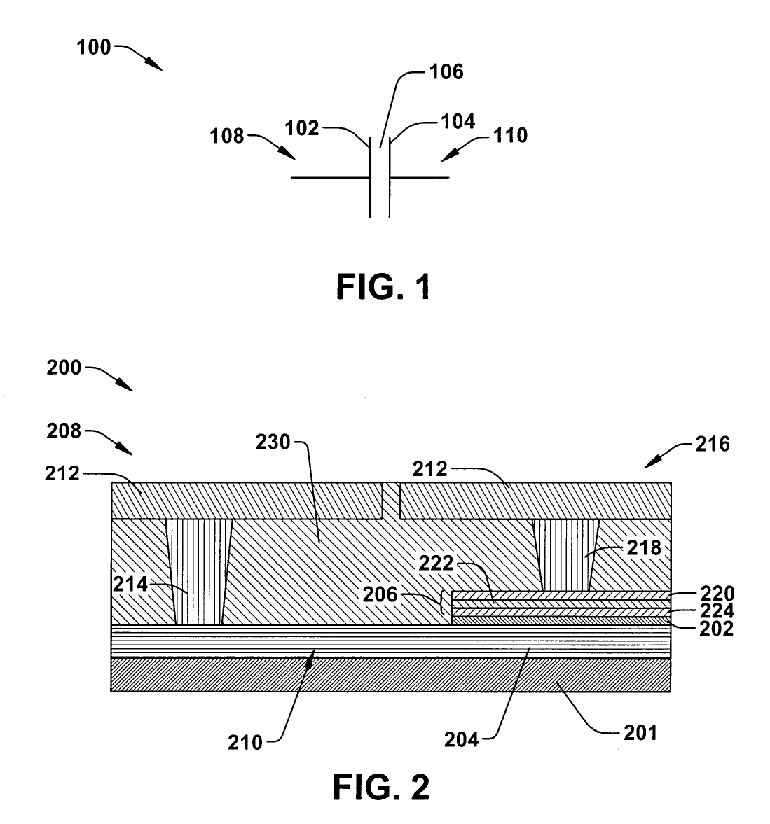

Referring now to FIG. 1, one can see a capacitor in accordance with aspects of the present invention. The capacitor 100 includes a pair of electrodes 102, 104 that are separated by a capacitor dielectric layer 106. Electrical connections 108, 110 are coupled to the electrodes 102, 104, respectively. Although in various embodiments the electrodes may be illustrated and described as a “first electrode” and a “second electrode”, it will be appreciated that these elements may be interchanged and that the use of these terms are merely illustrative of examples of how the present invention can be implemented. Thus, the first electrode may exhibit characteristics of the second electrode and vice versa.

During operation of the capacitor 100, a voltage bias is applied across the capacitor dielectric layer 106 between the first and second electrodes 102, 104. The capacitor dielectric layer 106 has an associated dielectric constant, which relates to the amount of electrostatic energy that can be stored per unit area at the given thickness. As the voltage bias increases, at some point the voltage bias between the electrodes will be greater than the breakdown voltage the dielectric layer can withstand. At this point, energy will discharge from the first electrode to the second electrode, thereby reducing the voltage across the electrodes. In various embodiments, such a capacitor could be used for energy storage, signal processing, filtering, or any number of other tasks.

As mentioned, some capacitors suffer from a condition where the contacts landing on the top conductive plate 102 or 104 can punch-through the top plate and the dielectric layer if there are any cracks in the top plate, thereby shorting out the capacitor and substantially compromising the capacitor's ability to store charge.” In one embodiment where room temperature TiN is used as a conductive layer, one of the electrodes 102, 104 can comprise a number of inter-layers to prevent top plate “cracks”. These inter-layers can be configured to cooperatively interrupt columnar growth of TiN, for example, thereby preventing “cracking”.

Referring now to FIG. 2, one can see another embodiment of a capacitor 200. FIG. 2 could relate to, for example, “donut”-type capacitors or rectangular-type capacitors, among others. In general, the capacitor 200 shown in FIG. 2 is formed over a semiconductor substrate 201, upon which successive conducting layers (e.g., conductive layer 212) and insulating layers (e.g., inter-level dielectric 230) are formed to produce the end device. In one embodiment, the substrate could be little more than a semiconductor wafer (e.g., GaAs wafer, Si wafer, SOI wafer, etc.), while in other embodiments substrate could include intricately constructed devices and/or wiring (e.g., MOSFETs, BJTs, diodes, etc.). Depending on implementation, the capacitor 200 could be a discrete part or could be integrated into an integrated circuit device.

As shown the capacitor 220 includes a capacitor dielectric layer 202 sandwiched between a first electrode 204 and the second electrode 206. A first electrical connection 208 is connected to the first electrode 204, wherein the first electrical connection may comprise at least a portion of a first conductive layer 210, second conductive layer 212, and at least one contact 214 that couples the first conductive layer 210 to the second conductive layer 212. A second electrical connection 216 is connected to the second electrode 206, wherein the second electrical connection may comprise at least a portion of the second electrode 206, the second conductive layer 212, and at least one contact 218 that couples the second electric 206 to the second conductive layer 212.

During operation, the capacitor 200 may operate in a manner similar to that of capacitor 100 previously discussed.

In one embodiment, the second electrode 206 can include multiple inter-layers to prevent defects in the capacitor top plate 206. Although any number of inter-layers could be used, the illustrated embodiment includes three inter-layers, namely: a top inter-layer 220, a middle inter-layer 222, and a bottom inter-layer 224. One or more of these inter-layers can be a dense semi-crystalline layer that has a different lattice structure than two other layers surrounding it.

By using at least one dense semi-crystalline or amorphous inter-layer within the second electrode, defects in the capacitor top plate can be limited. In one embodiment the middle inter-layer 222 can comprise a dense semi-crystalline inter-layer that interrupts the columnar growth of the bottom inter-layer 224 by forcing the top inter-layer 220 to re-nucleate, thereby shifting the columnar structure of the top inter-layer 220 with respect to the bottom inter-layer 224. This alleviates crack propagation through the second electrode 206. In other words, a dense semi-crystalline inter-layer within the second electrode can deflect a crack that is propagating down a columnar boundary of the top inter-layer along the interface between the two inter-layers 220, 222. Thus, the downward propagation of a crack will be stopped. As the number of inter-layers within the second electrode increases, it becomes less likely that a “crack” will propagate through second electrode into the capacitor dielectric layer.

Further, the inter-layers can comprise any suitable compound that facilitates the prevention of defects. For purposes of illustration, suitable compounds could include, but are not limited to: titanium, molybdenum, platinum, tantalum; and the like. For example, in one embodiment, the three inter-layers 220, 222, 224 could comprise TiN, Ti, TiN, respectively. In other embodiments, the three inter-layers 220, 222, 224 could comprise TiN—Pt—TiN, TiN—Ta—TiN, or TiN—Mo—TiN, respectively.

In various embodiments, the inter-layers can have a varied thickness relative to one another. For example, in one exemplary embodiment, the bottom inter-layer 224 is thicker than the top inter-layer 220. Such a configuration may be useful, for example, where cracks attempt to propagate from the top inter-layer through the bottom inter-layer. In one embodiment, the bottom layer 224 could comprise TiN having a thickness of approximately 900 Å, the middle layer 222 could comprise Ti having a thickness of approximately 500 Å, and the top layer 220 could comprise TiN having a thickness of approximately 200 Å. It will be appreciated, however, that the present invention is not limited to this number of layers, composition, or thickness, but rather the claims delineate the scope of the invention as set forth below.

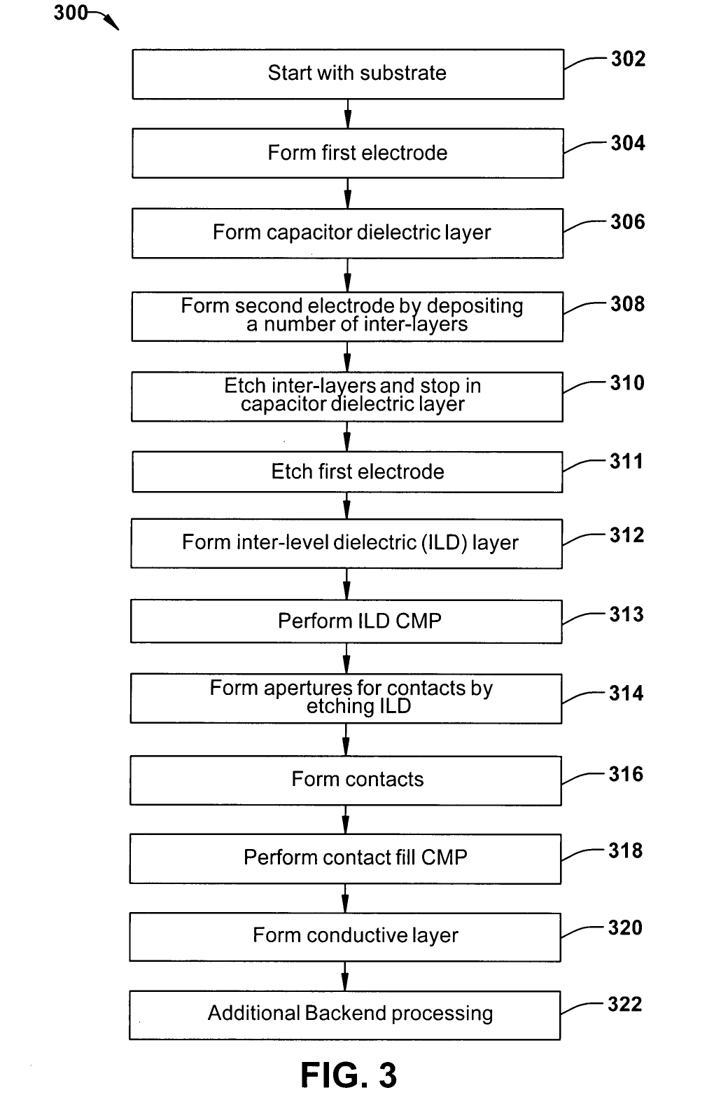

An exemplary method for forming a capacitor in accordance with the present invention is illustrated in FIG. 3. While the method 300 is illustrated and described below as a series of acts or events, it will be appreciated that the present invention is not limited by the illustrated ordering of such acts or events. For example, some acts may occur in different orders and/or concurrently with other acts or events apart from those illustrated and/or described herein, in accordance with the invention. In addition, not all illustrated steps may be required to implement a methodology in accordance with the present invention. Furthermore, the methods according to the present invention may be implemented in association with the devices and systems illustrated and described herein as well as in association with other structures not illustrated.

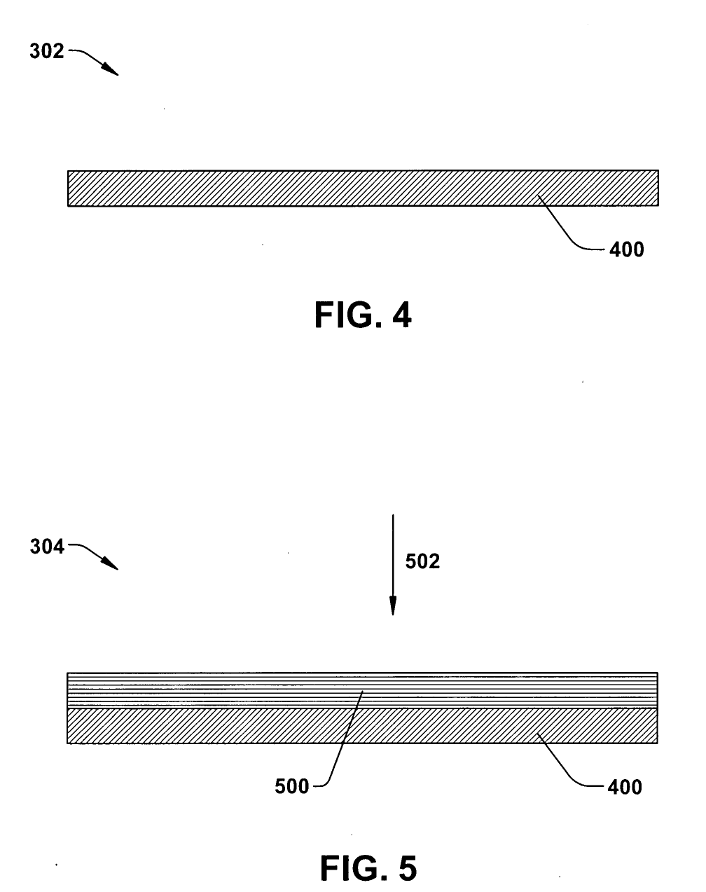

Method 300 is now described with reference to a flow diagram (FIG. 3) and schematic representations (FIGS. 4-16). The illustrated flow diagram shows general functional steps, while the schematic representations show structural features during the various stages of manufacture. It will be appreciated that the figures relate to the construction of a capacitor having a second electrode with three inter-layers for purposes of simplicity and consistency, although the method could be extended to any number of inter-layers.

As shown in FIG. 3, the method 300 starts at 302 with a substrate. In 304 a first electrode is formed over the substrate. Next, in 306 a capacitor dielectric layer is formed over the first electrode. In 308, second electrode is formed by depositing a number of inter-layers. In 310, the inter-layers are etched, wherein such etching may stop on the capacitor dielectric layer. In 311, the first electrode is etched. In 312, the inter-level dielectric (ILD) layer is formed. In 313, CMP is performed to planarize the ILD structure. In 314 contact apertures are formed by etching the inter-level dielectric. In 316, contacts are formed. In 318, CMP is performed to remove the contact fill material everywhere on the die except from within the contacts. At 320 another conductive layer is formed, after which additional backend processing can be performed at 322.

Referring now to FIG. 4, the method 300 starts at 302 with a semiconductor substrate 400, upon which successive conducting layers and insulating layers can be formed to produce the end device. In one embodiment, the substrate could be little more than a semiconductor wafer (e.g., GaAs wafer, Si wafer, SOI wafer, etc.), while in other embodiments substrate could include intricately constructed devices and/or wiring (e.g., MOSFETs, BJTs, diodes, etc.).

In FIG. 5, the method 300 deposits 502 a first conductive layer 500 over the substrate 400. The first conductive layer 500 will be suitably processed whereby least a portion of the first conductive layer will constitute a first electrode. In one embodiment the first conductive layer may be a metal, such as Cu, Al, TaN, TiN, TiW, and the like. In addition, the first conductive layer may be formed by sputtering, CVD, PVD, and the like.

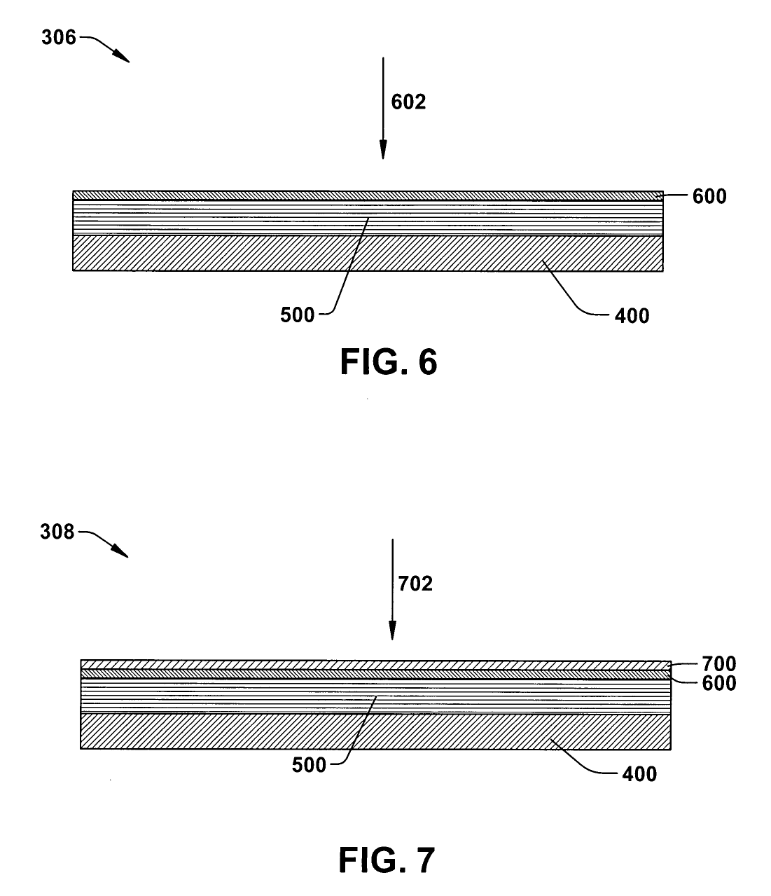

In FIG. 6, the method 300 deposits 602 dielectric layer 600 over the first conductive layer and the substrate. In this dielectric layer 600 could comprise any insulator including but not limited to: oxide, spin-on-glass, high-k dielectric, low-k dielectric, and the like. In typical embodiments the dielectric layer 600 will be relatively thin, although in other embodiments it need not be. For example, in one embodiment, the dielectric layer could have a thickness of approximately 200 Å or less.

In FIG. 7-9, the material of the second electrode is formed by depositing a number of inter-layers over the capacitor dielectric layer. In one embodiment, the number of inter-layers is formed using a “no air break” process, such that no oxidation will occur between successive inter-layers. For example, the inter-layers could be formed by using a number of chambers where in each chamber is a different sputtering source, but where the wafer is transferred directly from one chamber to the next while continuously kept under vacuum or other low-pressure conditions. In addition, the second electrode may be formed at ambient temperatures. This may be advantageous, for example, in embodiments where aluminum or other metals with relatively low melting points have been used in previous processing steps (e.g., for metal 1 or metal 2 layers).

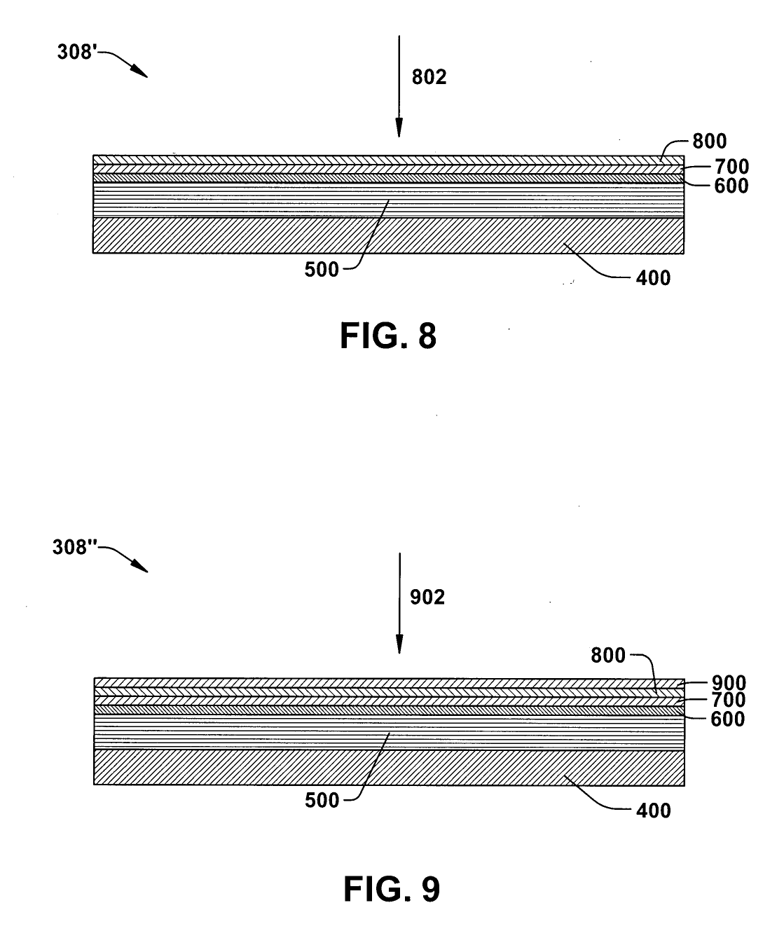

In one embodiment, a bottom inter-layer 700 comprising TiN is deposited 702 at a thickness of approximately 900 Å (FIG. 7). A middle inter-layer 800 comprising Ti or some other dense semi-crystalline inter-layer is then deposited 802 at a thickness of approximately 500 Å (FIG. 8). A top inter-layer 900 comprising TiN can then be deposited 902 at a thickness of approximately 200 Å (FIG. 9). Other inter-layers could also be deposited as previously alluded to.

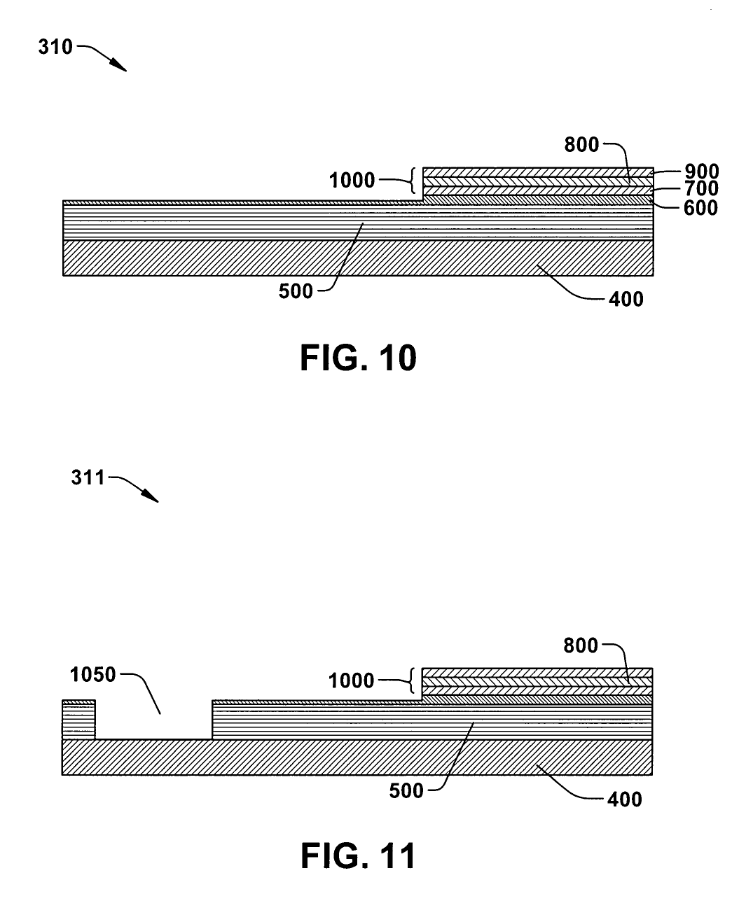

In FIG. 10, the wafer is patterned (e.g., by photoresist or any other method), after which the inter-layers 900, 800, 700 and some thickness of the dielectric layer 600 are etched. This patterning and etching process forms the first electrode in the conductive layer 500 and a second electrode 1000 associated therewith, wherein the dielectric layer 600 is sandwiched between the electrode of the conductive layer 500 and the second electrode 1000. A plasma dry etch process with high selectivity to the dielectric layer is preferable to etch electrode 1000. This will provide good critical dimension control of the top electrode which is typically used for high precision capacitors where capacitor matching is an important parameter. In the illustrated embodiment, the etching removes some, but not all of the dielectric layer 600, thereby forming a “step” in the dielectric layer. In other embodiments, the entire dielectric layer 600 could be removed.

In FIG. 11, the first electrode is etched. This etch typically removes a “slice” 1050 of the first electrode, thereby allowing electrical isolation or an individual electrical connection to the capacitor when it is ultimately formed. In the illustrated embodiment where a portion of the capacitor dielectric layer remains, the etch will remove the remaining capacitor dielectric layer and the underlying conductive layer as shown.

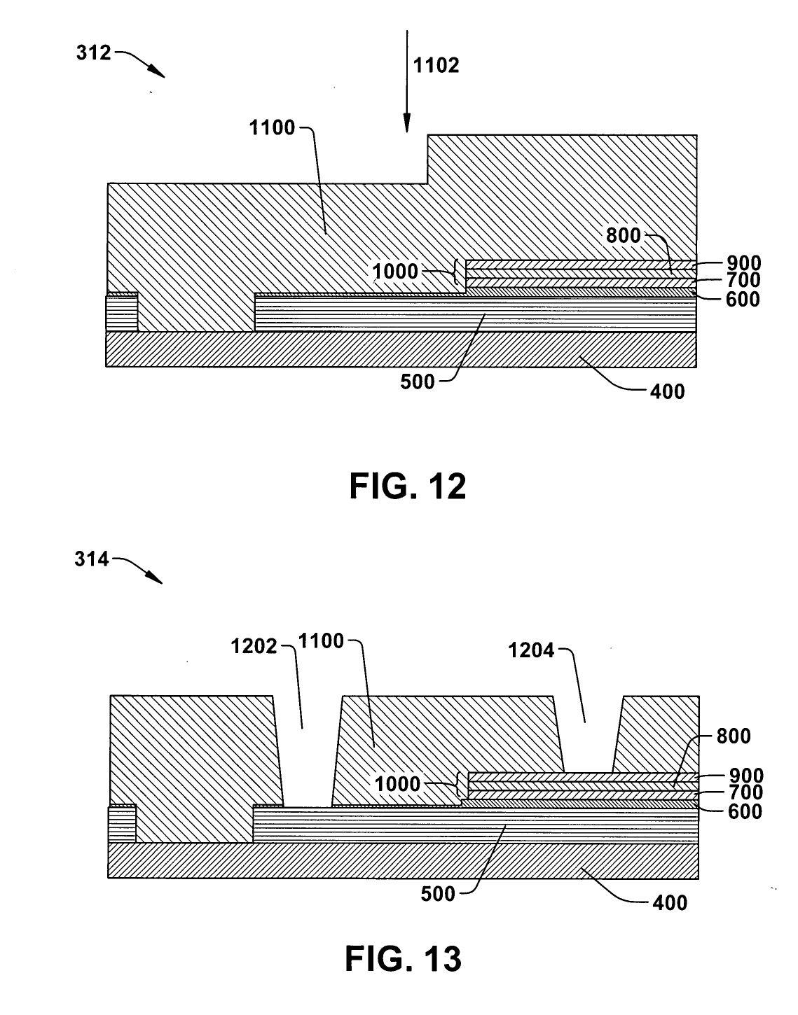

In FIG. 12, an interlevel dielectric 1100 is deposited 1102 over the existing structure. The interlevel dielectric 1100 is typically substantially thicker than the capacitor dielectric layer 600. The interlevel dielectric 1100 could comprise for example oxide, spin on electric, low-k dielectric, high-k dielectric, and the like. After the interlevel dielectric is deposited, CMP may be performed to planarize the step in the interlevel dielectric (not shown).

In FIG. 13, a pattern is applied over the interlevel dielectric 1100 and the interlevel dielectric is etched to form contact apertures 1200. Typically, a first contact aperture 1202 stops at approximately the top of the first conductive layer 500, and a second contact aperture 1204 stops at approximately the top of the second electrode 1000 (e.g., top surface of top inter-layer 900).

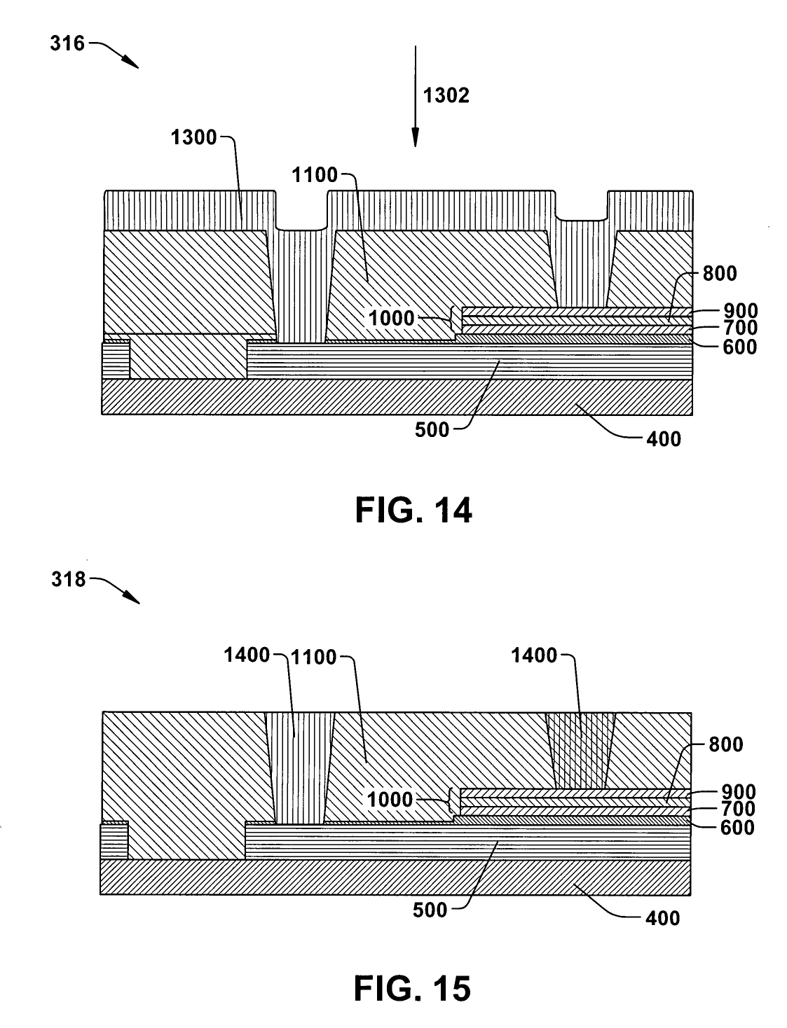

In FIG. 14, the contact material 1300 is deposited 1302 over the existing structures. The contact material 1300 will be applied to “fill” the contact apertures 1200. In one embodiment the contact material comprises tungsten, although other suitable contact materials could be used.

In FIG. 15, chemical mechanical polishing (CMP) is used to substantially remove the “fill material” from all areas except the contact holes.

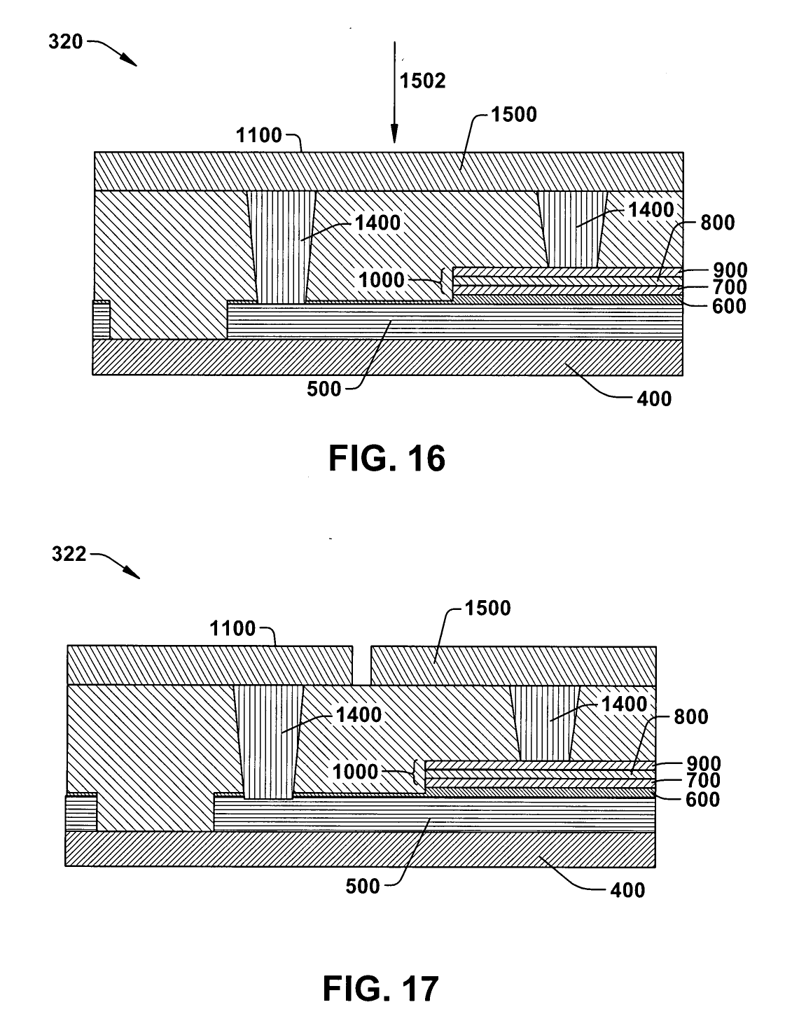

In FIG. 16, second conductive layer 1500 is deposited 1502 over the substantially planarized structure.

Lastly, in FIG. 17 the second conductive layer 1500 is patterned and etched, thereby providing the necessary functionality for the device. Additional backend processing, including the deposition and patterning of additional conductive layers could also be carried out.

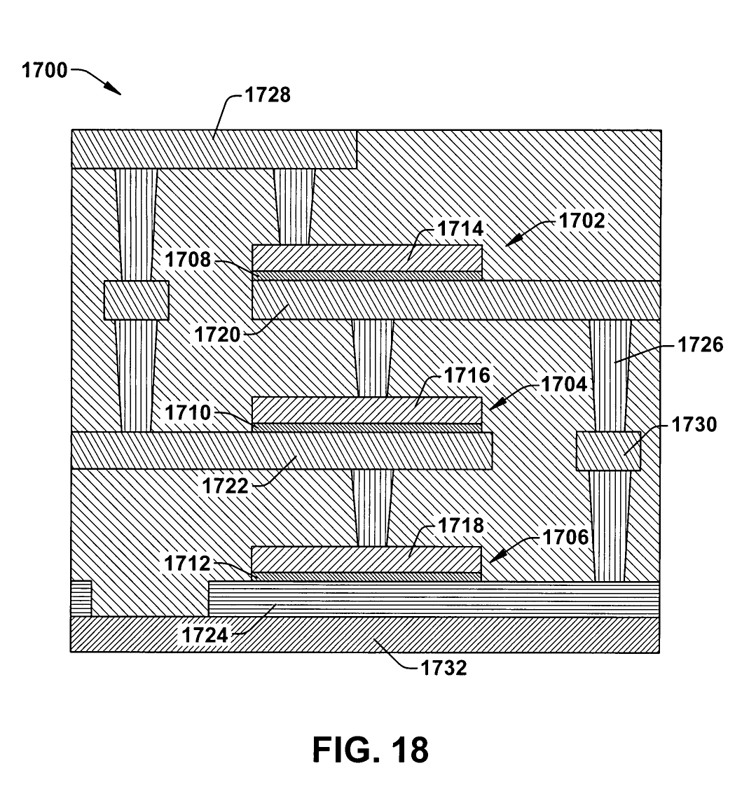

Referring now to FIG. 18, one can see one embodiment of a “stacked” capacitor in accordance with aspects of the invention. The stacked capacitor includes three capacitors that are disposed over a semiconductor substrate, although any number of capacitors could be so disposed. Each capacitor comprises a capacitor dielectric layer between a top electrode and a bottom electrode. The capacitors are connected in parallel and are vertically disposed relative to one another and relative to the semiconductor substrate.

As shown, the three capacitors 1702, 1704, 1706 each include a capacitor dielectric layer 1708, 1710, 1712, respectively that is sandwiched between a top electrode 1714, 1716, 1718, respectively, and the bottom electrode 1720, 1722, and 1724, respectively. The three capacitors connected in parallel by a number of electrical connections associated with each capacitor. These electrical connections may include contacts or vias (e.g., 1726), horizontal conductive layers (e.g., 1728 or 1730). As with previously discussed embodiments, a stacked capacitor may be formed over a semiconductor substrate 1732.

In the illustrated embodiment, the top electrode 1714 of the first capacitor 1702 is operably coupled to the bottom electrode 1722 of a second capacitor 1704. The top electrode 1714 of the first capacitor is further coupled to the top electrode 1718 of a third capacitor 1706. Further, the bottom electrode 1720 of the first capacitor 1702 is coupled to the top electrode 1716 of the second capacitor. These of electrodes 1720, 1716 are also coupled to the bottom electrode 1724 of the third capacitor 1706. Thus it will be appreciated, that the capacitors 1702, 1704, 1706 are coupled together in parallel fashion.

Variations of the stacked capacitor are also possible. For example, the electrodes could be coupled in other ways relative to one another. In one embodiment, for example the top electrode 1714 of the first capacitor 1702 could be coupled to the top electrode 1716 of the second capacitor 1704. In addition, the term “vertically disposed to one another” does not mean that the capacitors must be vertically aligned (i.e., the edges of the electrodes are aligned), although they could be aligned. The term merely means that one or more of the capacitors are formed in different conductive layers. These conductive layers could include but are not limited to: Cu or Al metal layers (e.g., metal 1, metal 2, metal 3), and polysilicon layers, among others.

In one embodiment one of the electrodes of the stacked capacitor (e.g., electrode 1714, 1716, or 1718) could include multiple inter-layers. Thus, for example, one or more of the top electrodes could comprise TiN, Ti, TiN inter-layers as discussed with reference to FIG. 2, or some other inter-layer structure.

While the invention has been illustrated and described with respect to one or more implementations, alterations and/or modifications may be made to the illustrated examples without departing from the spirit and scope of the appended claims. In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations of the invention. In addition, while a particular feature of the invention may have been disclosed with respect to only one of several implementations, such feature may be combined with one or more other features of the other implementations as may be desired and advantageous for any given or particular application. Furthermore, to the extent that the terms “including”, “includes”, “having”, “has”, “with”, or variants thereof are used in either the detailed description and the claims, such terms are intended to be inclusive in a manner similar to the term “comprising”.

What is claimed is:

1. A capacitor, comprising:
a first capacitor electrode;
a capacitor dielectric layer along-side the first capacitor electrode; and
a second capacitor electrode along-side the capacitor dielectric layer and comprising a number of inter-layers that are configured to prevent defects in the second capacitor electrode.

2. The capacitor of claim 1, wherein the number of inter-layers are configured to cooperatively interrupt the columnar microstructures of the first or second capacitor electrode.

3. The capacitor of claim 1, wherein at least one of the number of inter-layers is a dense semi-crystalline inter-layer that interrupts columnar growth between another two of the number of inter-layers which are disposed on opposite sides of the at least one inter-layer.

4. The capacitor of claim 1, wherein one of the number of inter-layers is a sandwich layer that comprises at least one of: Ti, Mo, Pt, or Ta; and other inter-layers surrounding the sandwich layer comprise at least one of: TiN, TiW, TaN.

5. The capacitor of claim 1, wherein a first thickness associated with one of the number of inter-layers is greater than a second thickness associated with another of the number of inter-layers.

6. The capacitor of claim 1, wherein the number of inter-layers are deposited at approximately ambient temperature or higher temperatures.

7. The capacitor of claim 6, wherein the number of inter-layers comprise at least three inter-layers, wherein two of the at least three inter-layers comprise substantially similar compounds and another of the at least three inter-layers comprises a different compound.

8. The capacitor of claim 7, wherein the two inter-layers comprise TiN, and the another inter-layer comprises Ti.

9. A capacitor, comprising:
a first electrical connection existing directly or indirectly over a semiconductor substrate;
a first capacitor electrode coupled to the first electrical connection;
a capacitor dielectric layer adjacent to the first capacitor electrode;
a second capacitor electrode adjacent to the capacitor dielectric layer and comprising a number of inter-layers that are configured to cooperatively interrupt columnar growth of the second capacitor electrode; and
a second electrical connection coupled to the second capacitor electrode.

10. The capacitor of claim 9, wherein the first electrical connection comprises:
a first conductive layer; and
a contact that spans at least one dielectric layer and thereby couples the first conductive layer to the first capacitor electrode.

11. The capacitor of claim 10, wherein the second electrical connection comprises:
a second conductive layer; and
a contact that spans at least one dielectric layer and thereby couples the second conductive layer to the second capacitor electrode.

12. The capacitor of claim 11, wherein the number of inter-layers are configured to cooperatively interrupt columnar growth of the second capacitor electrode to eliminate crack formation in the second capacitor electrode.

13. The capacitor of claim 12, wherein the number of inter-layers comprises:
at least three inter-layers that are adjacent to one another;
wherein at least two of the inter-layers comprise a common conductive material and at least one of the inter-layers comprises another conductive material.

14. The capacitor of claim 13, wherein at least two non-adjacent inter-layers of the number of inter-layers comprise TiN, and at least one inter-layer between the non-adjacent inter-layers comprises Ti.

15. A method for manufacturing a capacitor on a semiconductor substrate, comprising:
forming a first capacitor electrode over the semiconductor substrate;
forming a capacitor dielectric layer over the first capacitor electrode; and
forming a second capacitor electrode over the capacitor dielectric layer by depositing a number of inter-layers, wherein the number of inter-layers are configured to prevent defects in the second capacitor electrode.

16. The method of claim 15, wherein the number of inter-layers are configured to prevent defects in the second capacitor electrode that occur after the forming of the second capacitor electrode but during further processing of the capacitor.

17. A stacked capacitor, comprising:
a number of capacitors disposed over a semiconductor substrate, wherein each capacitor comprises a capacitor dielectric layer between a top electrode and a bottom electrode; and
wherein the number of capacitors are connected in parallel and are vertically disposed relative to one another and relative to the semiconductor substrate.

18. The stacked capacitor of claim 17, wherein a top electrode of a first of the number of capacitors is coupled to one of the electrodes of a second of the number of capacitors.

19. The stacked capacitor of claim 18, wherein the top electrode of the first capacitor is further coupled to one of the electrodes of a third of the number of capacitors.

20. The stacked capacitor of claim 17, wherein a bottom electrode of a first of the number of capacitors is coupled to a top electrode of a second of the number of capacitors.

21. The stacked capacitor of claim 17, wherein at least one of the top electrodes comprises multiple inter-layers.
